(19) United States
(12) Patent Application Publication
(10) Pub. No.: US 2026/0196748 A1
(43) Pub. Date: Jul. 9, 2026

(54) CONNECTING SYSTEM FOR CONTACT-CONNECTING BUSBARS HAVING DIFFERENT THICKNESSES

(71) Applicant: SUMIDA Components & Modules GmbH, Obernzell (DE)

(72) Inventors: Amel BAJRAKTAREVIC, Neuhaus (DE); Stefan HUNDHAMMER, Osterhofen (DE); Tobias NODES, Obernzell (DE); Iyad KEBAISY, Furstenzell (DE); Lars MESSERSCHMIDT, Neukirch OT Koitzsch (DE)

(21) Appl. No.: 18/867,666

(22) PCT Filed: May 23, 2023
(86) PCT No.: PCT/EP2023/063827

§ 371 Date: Nov. 20, 2024

(30) Foreign Application Priority Data
May 31, 2022 (DE) 10 2022 113 717.1

(51) Int. Cl. H01R 4/58

(52) U.S. Cl. CPC H01R 4/58

(57) ABSTRACT

The disclosure provides a connecting system for contact-connecting busbars having different thicknesses. The connecting system includes a first busbar element having a first thickness and a second busbar element having a second thickness. The first thickness is greater than the second thickness. In this case, the first busbar element has an opening that is formed in the first busbar element and the second busbar element has a plug-in connector that is integrally formed on the second busbar element and is designed to form a plug-in connection with the opening formed in the first busbar element.

### FIELD OF INVENTION

The present invention relates to a connecting system for contact-connecting busbars having different thicknesses, in particular a plug-in connecting system for connecting busbars having different thicknesses.

### BACKGROUND

Applications of assemblies are known in which busbars having different thicknesses are to be connected to one another. For example, in battery module applications or on-board distribution and supply systems of electric vehicles, busbars in the form of lead frames, which are equipped with resistors and capacitors, are often mechanically and electrically coupled with busbars that are connected to power sources as supply rails, wherein supply rails have a greater thickness than lead frames. In this context, lead frames and supply rails up to now have been connected either by means of additional connection elements provided between the supply rail and the lead frame, or by means of complex push-through connections, which generally require mechanical reworking of busbars of greater thickness in order to achieve a reliable push-through connection. Irrespective of the type of connection, the material costs for providing such a connection are increased on the one hand, while on the other hand, additional sources of error that affect the reliability of connected busbars are introduced by additional interfaces and/or processing steps. For example, with known push-through connections, extensive mechanical reworking, e.g. milling, water jet cutting, eroding, etc., is required to produce a hole with the required tolerance, which increases the manufacturing costs for producing reliable connections, so that industrial-scale manufacturing can be uneconomical. A common approach to connecting busbars is often to weld two connection partners together on their flat sides.

The use of punched holes in busbars requires additional connection elements, which on the one hand increase the material costs for the end product and on the other hand introduce an additional interface and thus an additional source of error.

From document DE 196 22 895 A1, a method for manufacturing a connecting device for a set of busbars is known, which are arranged parallel to each other at a distance from each other and encased in an insulating cast material. In this case, each busbar comprises connection elements that are attached to busbars.

In document US 2011/0195585 A1, a connecting device for connecting at least one external electrical conductor to an electrical connecting system of a solar module is described, wherein the current-carrying parts thereof are formed as busbars. These busbars are mounted on a carrier element and each connected to an external electrical connecting cable.

Document US 2012/0015550 A1 describes a battery connector used in a power unit mounted on a hybrid or electric vehicle. The battery connector comprises a plurality of busbars for connecting a plurality of batteries, wherein a positive electrode is successively connected to an adjacent negative electrode. Through a terminal, a busbar is connected to a lead wire.

### SUMMARY

In view of the background described above, one problem is to provide a connecting system for contact-connecting busbars having greatly varying thicknesses, which system is not susceptible to errors, however, is space-saving and reliable in process, has a simplified structure and can be provided at low cost.

In one aspect, the present invention provides a connecting system for contact-connecting busbars having different thicknesses. The connecting system can be formed as a plug-in connecting system, for example with a push-through connection.

In illustrative embodiments herein, the connecting system comprises a first busbar element having a first thickness and a second busbar element having a second thickness, wherein the first thickness is greater than the second thickness. The first busbar element has an opening formed in the first busbar element and the second busbar element has a plug-in connector integrally formed on the second busbar element, which is configured for a plug-in connection with the opening formed in the first busbar element.

A busbar element is to be understood as constituting a section of material made of an electrically conductive material that is used to manufacture a busbar or lead frame or at least constitutes a section of a busbar or lead frame. Thus, a busbar element can be a busbar or a piece of material from which a busbar or a lead frame is formed by further processing, so that a piece of material, e.g. made of copper or aluminum, which serves as the starting point for the manufacture of a busbar, such as a metal sheet from which a busbar is punched out, is also regarded as a busbar element. In illustrative examples, for example, the second busbar element is punched out of a lead frame or a piece of material suitable for manufacturing a lead frame, wherein the correspondingly formed second busbar element has a plug-in connector integrally formed thereon. This means that a lead frame can be realized as an extension to the plug-in connector without the need for additional connection elements between the plug-in connector and the lead frame. By providing the plug-in connector on the second busbar element, the plug-in connector can be more easily provided on the second busbar element than on the first busbar element.

A thickness in some exemplary configurations represents an averaged thickness obtained by averaging a thickness across one of the first and second busbar elements. For this, known techniques can be used to average a magnitude, such as geometric or arithmetic averaging over a grid of measured thickness values. Alternatively, at least one of the first and second busbar elements may have a (substantially) constant thickness, in particular a thickness that is considered constant within the scope of a usual or desired tolerance requirement for the thickness of busbar elements. In specific, non-limiting examples, a thickness with thickness variation of at most 20%, or at most 15%, or at most 10%, or at most 5%, or at most 1%, may be considered substantially constant.

In illustrative embodiments of this aspect, the first busbar element that has the opening formed in the first busbar element may have the first thickness at least at a region of the first busbar element where the opening is formed. For example, the opening can be formed in a section of the first busbar element, wherein only this section has the first thickness and the first busbar element otherwise has a third thickness smaller than the first thickness and optionally smaller than or equal to the second thickness. For example, the first busbar element can have the first thickness at least at this section. This ensures that the first busbar element provides a stable plug-in connection at least at the opening.

In illustrative embodiments of this aspect, the second busbar element that has the plug-in connector integrally formed on the second busbar element can have the second thickness at least at a region of the second busbar element where the plug-in connector is formed. For example, the plug-in connector can be formed from a section of the second busbar element, wherein this section has the second thickness. For example, the second busbar element can have the second thickness at least at this section. Thus, it is achieved that the second busbar element is formed at least at this region to provide a plug-in connector. In illustrative configurations herein, the second busbar element has the second thickness at least at the plug-in connector. Thus, for example, the second busbar element at the plug-in connector can have the second thickness as a constant or substantially constant thickness, or, if the second thickness at the plug-in connector constitutes an averaged thickness, a maximum thickness at the plug-in connector can be smaller than the first thickness.

The connecting system according to this aspect can be preferably used for contact-connecting busbars with greatly differing thicknesses, such as connecting at least one lead frame (with or without components on or through the lead frame) to at least one busbar that is connected to a power supply. In particular, no additional connection elements are required in and/or during rework on the connecting system to form a connection between the two busbar elements. This provides connecting systems that are not susceptible to errors, space-saving and reliable for contact-connecting busbars with greatly differing thicknesses with a simplified structure and at low cost.

In a preferred configuration of this aspect, the first busbar element can comprise a busbar for the power supply. This makes it possible to use the connecting system preferably in combination with a power supply system.

In a further preferred configuration of this aspect, the second busbar element can comprise a lead frame element. In this way, a plug-in connector can be provided as an integral coupling part in a simple manner. In addition, the lead frame element can provide an electrical component. For example, lead frame elements connected to busbar elements of different electrical polarity and/or different electrical potential can form a capacitive component. In illustrative examples herein, a connecting system may comprise a plurality of first busbar elements, each coupled to at least one second busbar element, wherein at least one capacitive component is provided.

In a further preferred configuration of this aspect, the opening may be a hole punched in the first busbar element. This allows the connection system to be provided at low cost, since the opening is provided with little effort.

In a further preferred embodiment of this aspect, the plug-in connector may be configured as a rolled or bent plug. This provides a simple and stable configuration of the connector. In some illustrative examples herein, the rolled or bent plug may be provided in the form of a rolled or bent socket or a round pin. This constitutes a stable configuration that provides a reliable connection to the opening. For example, a very stable configuration can be achieved by a round pin that is rolled multiple times, having, for example, spiral round pin sections that are tightly rolled so that a bending stiffness is increased.

In a further preferred configuration of this aspect, the connector can be configured to form a form-fitting and force-fitting connection with the opening and can be connected to the opening. In this way, a connection that is not susceptible to errors and is process-reliable is produced in a simple manner.

In a further preferred configuration of this aspect, a ratio of the first thickness to the second thickness can be greater than 1.5. In some illustrative examples herein, the ratio can be at least 2. This allows corresponding connecting systems to be used preferably in the coupling of lead frames with energy supply systems.

In a further preferred configuration of this aspect, the first thickness may be at least 2 mm and/or within the range of 3 to 4 mm. In some illustrative examples herein, the first thickness may be at least 2.5 mm. This allows corresponding connecting systems to be used preferably in combination with power supply systems.

In a further preferred configuration of this aspect, the second thickness can be less than 2 mm and/or in a range from 0.6 to 1.2 mm. In some illustrative examples herein, the second thickness can be at most 1.5 mm. In this way, corresponding connecting systems can be preferably used in coupling with lead frames.

In at least some of the configurations described above, busbar elements can be made of copper or aluminum or Cuponal (i.e., a copper-clad aluminum bimetal).

In at least some of the configurations described above, busbar elements can be at least partially coated with an insulating material for electrical insulation.

At least some of the configurations described above may have an opening with a diameter that has a ratio to the thickness of the first busbar element of at least 0.9.

At least some of the above configurations provide a connecting system for contact-connecting busbars having different thicknesses with geometric connections that offer very good conditions for a subsequent laser welding process.

### BRIEF DESCRIPTION OF DRAWINGS

Further advantages and illustrative embodiments of the aspects of the invention outlined above are described below with reference to the accompanying figures, which are not drawn to scale and in which:

FIG. 1 schematically shows a first busbar element according to some illustrative embodiments;

FIG. 2 schematically shows a second busbar element according to some illustrative embodiments;

FIG. 3 schematically shows the second busbar element from FIG. 2 as a punched blank in an early manufacturing phase according to some illustrative embodiments;

FIG. 4 schematically shows an arrangement of two busbar elements, each according to the second busbar element of FIG. 2, for implementing a capacitive component according to some illustrative embodiments; and

FIG. 5 schematically shows a connecting system in an exploded view according to some illustrative embodiments.

### DETAILED DESCRIPTION

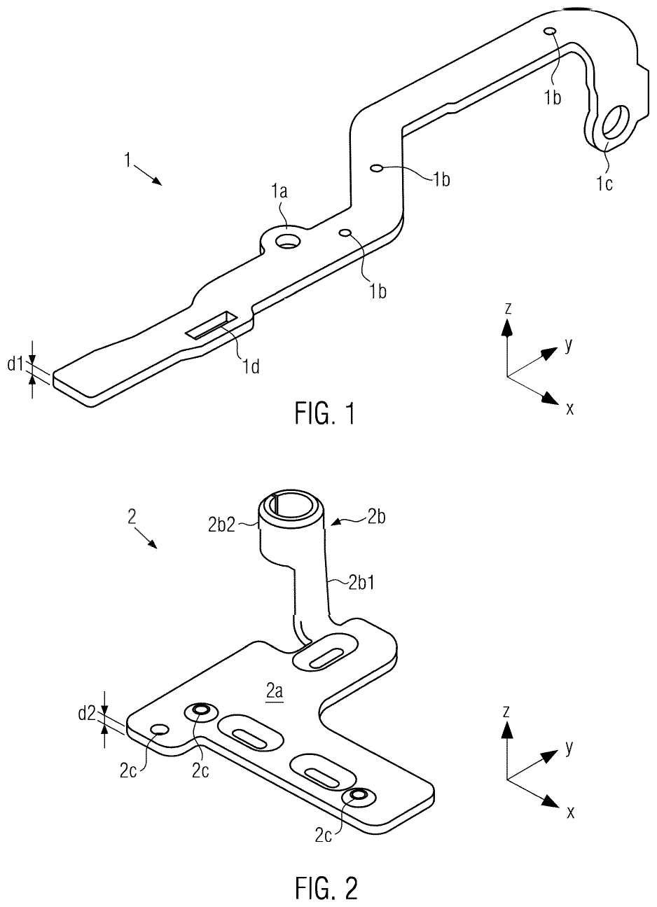

FIG. 1 schematically shows a first busbar element 1 in a perspective view. The first busbar element 1 can represent a busbar or a section of a busbar or a reworked busbar. The first busbar element 1 generally represents a rail-shaped element made of an electrically conductive material, for example copper and/or aluminum. The term “rail-shaped” means that the first busbar element 1 is elongated with a thickness d1, wherein elongated means that a length dimension (e.g., substantially parallel to a y-direction of an xyz coordinate system shown in FIG. 1) which is perpendicular to a width dimension (e.g. substantially parallel to an x-direction of the xyz coordinate system shown in FIG. 1) and to the thickness d1, is greater than the width dimension. The thickness d1 represents a constant or essentially constant or mean dimension of the first busbar element 1 along a thickness dimension (for example, essentially parallel to a z-direction of the xyz coordinate system shown in FIG. 1), which is oriented perpendicular to the length dimension and to the width dimension. In illustrative examples and according to the representation in FIG. 1, the width dimension can be greater than the thickness d1.

In descriptive embodiments, the thickness d1 can be at least 2 mm. For example, the thickness d1 can be at least 2.5 mm and/or in a range from 3 to 4 mm. This allows the first busbar element 1 to be used in high-voltage or high-current applications, for example as a connectable or connected supply rail.

In some examples, the busbar element 1 can be configured such that it only has the thickness d1 in one region, otherwise it has a different thickness, such as a thickness smaller than d1. For example, the busbar element 1 can be provided shaped with a variable thickness profile, wherein the thickness d1 is only specified in one region.

Further with reference to FIG. 1, the first busbar element 1 has an opening 1a, which is formed as a through-hole as shown. The opening 1a is formed at the region where the busbar element 1 has the thickness d1. For example, a diameter of the opening 1a can be at least 0.9*d1. The opening 1a can be circular in plan view and can be easily formed in the first busbar element 1 by punching in a preferred machining process. The busbar element 1 can be subjected to one or more bending processes and thus have a desired three-dimensional shape with at least one bend, so that sub-sections of the first busbar element 1 extend along at least two different spatial directions. For example, sub-sections can run along a direction parallel to the length dimension and at least one direction parallel to the width direction and/or a direction parallel to the thickness. In this context, a direction can also run at an arbitrary angle relative to a direction parallel to the length dimension if this direction is understood as a superposition of several directions, for example according to a definition of a scalar product formed in three-dimensional space, whereby an angle value is defined taking into account individual direction components and their values, as is generally known to a person skilled in the art.

In descriptive embodiments, the first busbar element 1 may have at least one further opening 1b, for example and without limitation three openings 1b (in particular also one opening, two openings or more than three openings), which are formed as blind holes or through-holes in the first busbar element 1. The openings 1b may have a cylindrical shape with a diameter that is smaller than the diameter of the opening 1a. For example, the diameter of the openings 1b may be smaller than 0.5*d1. The openings 1b can be provided for positioning the first busbar element 1 so that the openings 1b can serve for positioning the first busbar element 1 relative to a busbar support (not shown) by means of lugs (not shown) of the busbar support (not shown) provided for this purpose, wherein the lugs (not shown) are matched to the number of openings 1b and one lug (not shown) of the busbar support (not shown) each engages in an associated opening 1b.

According to the representation in FIG. 1 and in some illustrative embodiments, the first busbar element 1 may have one or more additional openings, for example and without limitation, opening 1c and/or opening 1d. Opening 1c may be formed correspondingly to opening 1a and may, for example, constitute a cylindrical through-opening. Alternatively, opening 1c can be configured as a blind hole. As shown, opening 1d is configured as a slot-shaped opening that is configured for the plug-in connection with a flat and rail-shaped mating plug-in element (not shown). Although opening 1d is shown as a through-opening for a push-through connection, this is not a restriction and, alternatively, opening 1d can represent a blind opening.

With reference to FIG. 2, a second busbar element 2 is shown in a perspective view with respect to an xyz coordinate system. The second busbar element 2 has a smaller thickness d2 compared to the first busbar element 1 from FIG. 1, wherein the thickness d2 is understood as a material thickness and represents a dimension essentially parallel to the z-axis in FIG. 2. In this respect, the second busbar element 2 can be described as less rigid or less massive compared to the first busbar element 1.

In illustrative embodiments, the second busbar element 2 is formed from a busbar or generally from a conductive material that can be permanently and reversibly deformed into a desired shape. For example, the second busbar element 2 can be formed from a sheet metal or lead frame material. In illustrative examples, the thickness d2 can be less than 2 mm, for example, the thickness d2 can be at most 1.5 mm and/or in a range from 0.6 to 1.2 mm.

Referring to FIG. 2, the second busbar element 2 has a body section 2a and a plug-in connector 2b formed integrally with the body section 2a. For example, the plug-in connector 2b can be mechanically and electrically connected to the body section 2a via a web section 2b1. A plug-in connection region 2b2 is formed at an end region of the web section 2b1 that is opposite the body section 2a. For example, the plug-in connection region 2b2 can be configured as a rolled socket. This does not constitute a restriction and the plug-in connection region 2b2 can alternatively be configured as a rolled pin or round pin or in a shape that generally functions as a plugin connector for engaging with a counter-opening in a further busbar element, in particular the first busbar element 1 from FIG. 1. The web section 2b1 can be bent so that it extends essentially parallel to the z-axis. This does not constitute a restriction and an orientation of the web section 2b1 relative to the body section 2a can be set such that it is expedient for forming a plug-in connection with a further busbar element, in particular the first busbar element 1 from FIG. 1.

According to the representation in FIG. 2 and in some illustrative embodiments, the second busbar element 2 may have one or more additional openings 2c. The one or more openings 2c may be formed as a cylindrical through-opening or as a blind hole and may be provided for positioning the second busbar element 2 so that the openings 2c may serve for positioning the second busbar element 2 relative to a busbar support (not shown) by means of lugs (not shown) of the busbar support (not shown) provided for this purpose, wherein the lugs (not shown) engage in the one or more openings 2c.

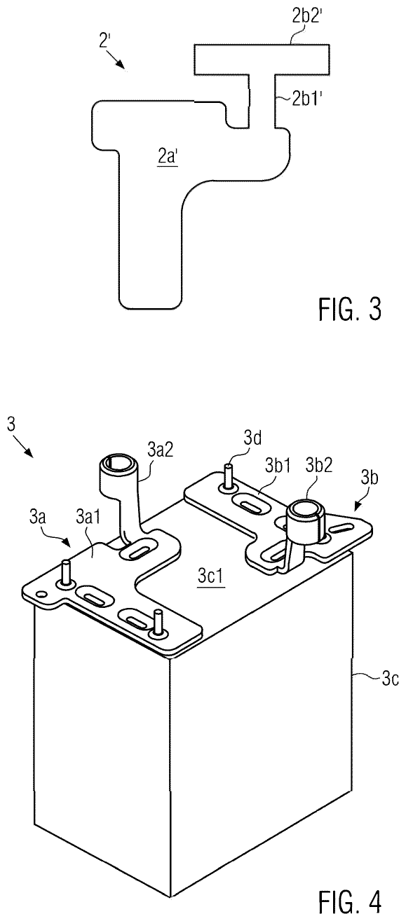

With reference to FIG. 3, the manufacture of the second busbar element 2 from FIG. 2 is now described according to some illustrative embodiments. In an initial manufacturing phase, a piece of starting material (not shown) can be provided, for example in the form of a metal piece such as a metal sheet, from which an initial busbar element 2′ is produced by means of one or more machining processes (cutting and/or punching processes and/or rolling process, etc.), as schematically shown in the plan view of FIG. 3. The initial busbar element 2′ is provided in a substantially flat shape, wherein the initial busbar element 2′ has a material thickness corresponding to the thickness d2 of the second busbar element 2 from FIG. 2. According to the illustration, the initial busbar element 2′ has a body portion 2a′ corresponding to the body portion 2a of the second busbar element 2 from FIG. 2. Furthermore, it has an essentially T-shaped section formed by a web section 2b1′, which merges substantially centrally into a web section 2b2′ oriented substantially transversely to it. This does not constitute a restriction and, alternatively, a substantially L-shaped section can be provided in which the web section 2b1′ merges eccentrically into the web section 2b2′ oriented transversely thereto. In either case, the web sections 2b1′ and 2b2′ are integrally formed with the body section 2a′.

In some illustrative embodiments, the initial busbar element 2′ can be formed by punching a piece of sheet metal and represents a punched blank. Punching represents a simple manufacturing process for the initial busbar element 2′, wherein a large number of pieces can be produced without great effort and with good reproducibility.

In a further processing step, the initial busbar element 2′ is subjected to a bending process so that the web section 2b2′ is formed into the plug-in connection region 2b2. For example, the plug-in connection region 2b2 can be obtained by round bending the web section 2b2′ in FIG. 3. By adjusting the shape of the web section 2b2′, a size of the plug-in connection region 2b2 to be produced is set and it can be seen that a form-fitting connection between the plug-in connector 2b of the second busbar element 2 from FIG. 2 and the opening 1a of the first busbar element 1 from FIG. 1 is achieved by matching the dimensions of the opening 1a and the plug-in connector 2b.

In some examples, the initial busbar element 2′ can be configured such that it has the thickness d2 only on the web section 2b2′, otherwise it has a thickness that deviates from this, such as an approx. greater thickness. For example, the initial busbar element 2′ can be provided shaped with a variable thickness profile, wherein the thickness d2 is defined only on the web section 2b2′.

With reference to FIG. 4, an arrangement 3 comprising a plurality of second busbar elements 3a and 3b is shown, which can implement a capacitive component when the second busbar elements 3a and 3b are supplied with different potentials. The second busbar elements 3a and 3b can, as shown, be substantially similar busbar elements, which can each substantially correspond to the second busbar element 2 shown in FIG. 2. This does not constitute a restriction and any shaped second busbar elements 3a and 3b can be provided.

Each of the second busbar elements 3a and 3b has a corresponding body section 3a1 and 3b1 that is integrally formed with a corresponding plug-in connector 3a2 and 3b2. The second busbar elements 3a and 3b can be arranged on a carrier 3c, wherein a positioning and orientation of the second busbar elements 3a and 3b can be specified by lugs 3d, which are formed in a surface 3c1 of the carrier 3c and engage with openings in the body sections 3a1 and 3b1.

In some illustrative embodiments, the carrier 3c may be formed from an electrically insulating material, so that the arrangement 3 as described above represents a capacitive component. This does not constitute a restriction and the arrangement 3 can provide an electrical resistance component, provided that the carrier 3c is formed from a suitable material that allows a resistive current path to be set between the busbar elements 3a and 3b. For example, an electrical resistance can be set by the carrier 3c through a suitable choice of material and/or suitable dimensions. Alternatively, resistive paths may be incorporated in the carrier 3c that provide an electrical resistance between the busbar elements 3a and 3b. In specific examples herein, an ohmic material may be selected for the carrier 3c or at least in sections in the carrier 3c, for example for ohmic paths in the carrier 3c between the busbar elements 3a and 3b.

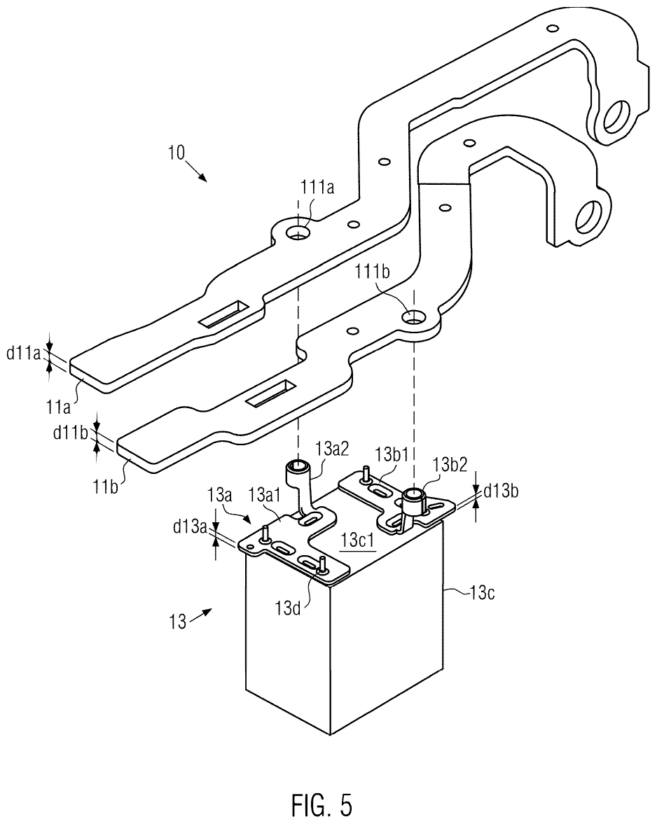

With reference to FIG. 5, a connecting system 10 is shown in a schematic exploded view according to some illustrative embodiments. As shown, the connecting system 10 is provided for contact-connecting busbars having different thicknesses. In this case, a busbar element 11a having a thickness d11a and having an opening 111a formed in the busbar element 11a is provided, which is electrically and mechanically coupled to a busbar element 13a having a thickness d13a. The busbar element 13a has a body section 13a1 and a plug-in connector 13a2 integrally formed on the second busbar element 13a, which is configured for a plug-in connection with the opening 111a, wherein the thickness d11a is greater than the thickness 13a. In this case, for the electrical and mechanical coupling between the busbar element 11a and the busbar element 13a, the plug-in connector 13a2 is configured for a form-fitting and force-fitting connection with the opening 111a and is connected to the opening 111a. For example, the plug-in connector 13a2 is coupled to the opening 111a to form a push-through connection and is pressed into the opening 111a in a form-fitting and force-fitting manner.

According to the presentation in FIG. 5, the busbar element 11a may correspond to the first busbar element 1 from FIG. 1, wherein the description for FIG. 1 is incorporated by reference at this point. In particular, the opening 111a in FIG. 5 is identified with the opening 1a in FIG. 1 and the thickness d11a in FIG. 5 is identified with the first thickness d1 in FIG. 1. Furthermore, the busbar element 13a in FIG. 5 may correspond to the second busbar element 2 from FIG. 2 or to one of the busbar elements 3a and 3b in FIG. 4, wherein the description for FIG. 1 is incorporated at this point by reference. In particular, reference signs d13a, 13a1 and 13a2 are identified with corresponding reference signs d2, 2a, 2b in FIG. 2 and with corresponding reference signs 3a1, 3b1, 3a2 and 3b2 in FIG. 4.

Further with reference to FIG. 5, the connecting system 10 can also provide a busbar element 11b with a thickness d11b and with an opening 111b formed in the busbar element 11b, which is electrically and mechanically coupled to a busbar element 13b with a thickness d13b. The busbar element 13b has a body section 13b1 and a plug-in connector 13b 2 integrally formed on the second busbar element 13b, which is configured for a plug-in connection with the opening 111b, wherein the thickness d11b is greater than the thickness 13b. In this context, for the electrical and mechanical coupling between the busbar element 11b and the busbar element 13b, the plug-in connector 13b2 is configured for the form-fitting and force-fitting connection with the opening 111b and is connected to the opening 111b. For example, the plug-in connector 13b2 is coupled to the opening 111b to form a push-through connection and is pressed into the opening 111b in a form-fitting and force-fitting manner.

According to the representation in FIG. 5, the busbar element 11b may correspond to the first busbar element 1 from FIG. 1, wherein the description for FIG. 1 is incorporated at this point by reference. In particular, the opening 111b in FIG. 5 is identified with the opening 1a in FIG. 1 and the thickness d11b in FIG. 5 is identified with the first thickness d1 in FIG. 1. Furthermore, the busbar element 13b in FIG. 5 may correspond to the second busbar element 2 from FIG. 2 or to one of the busbar elements 3a and 3b in FIG. 4, wherein the description for FIG. 1 is incorporated at this point by reference. In particular, reference signs d13b, 13b1 and 13b2 are identified with corresponding reference signs d2, 2a, 2b in FIG. 2 and with corresponding reference signs 3a1, 3b1, 3a2 and 3b2 in FIG. 4.

The connecting system 10 further includes a carrier 13c having a surface 13c1 in which a plurality of lugs 13d are formed. The lugs 13d engage with openings in the body sections 13a1 and 13b1 to fix the position of the busbar elements 13a and 13b on the carrier and the orientation of the busbar elements 13a and 13b relative to one another. In illustrative examples, the lugs 13d can be provided by pins integrally formed on the carrier 13c. In this way, a capacitive component 13 can be provided by the busbar elements 13a and 13b fixed on the carrier 13c, which is contact-connected by means of the busbar elements 11a and 11b in the connecting system 10 and coupled to an energy source (not shown). For example, in an illustrative and non-limiting application, the capacitive component 13 can implement a capacitive filter in an on-board system of an electric vehicle.

Although the connecting system 10 in FIG. 5 is shown with two busbar elements 11a and 11b, each coupled to a corresponding one of the busbar elements 13a and 13b, this does not constitute a restriction and instead of the explicitly shown two busbar connecting systems 11a, 13a and 11b, 13b, only one of the busbar connecting systems 11a, 13a and 11b, 13b can also be provided, as will now be described with regard to FIG. 5, wherein FIG. 5 shows a connecting system 10 for contact-connecting busbars having different thicknesses, wherein the connecting system 10 comprises a first busbar element 11a or 13a having a corresponding first thickness d11a or d11b and a corresponding second busbar element 13a or 13b having a corresponding second thickness d13a or d13b. In this case, the first thickness d11a or d11b is greater than the second thickness d13a or d13b. Furthermore, the first busbar element 11a or 11b has an opening 111a or 111b formed in the first busbar element 11a or 11b and the second busbar element 13a or 13b has a plug-in connector 13a2 or 13b2 integrally formed on the second busbar element 13a or 13b, which is configured for plug-in connection with the opening 111a or 111b formed in the first busbar element 11a or 11b. This does not constitute a limitation and, alternatively, more than the two shown busbar connecting systems 11a, 13a and 11b, 13b can be provided.

In summary, the following embodiments are described with reference to FIGS. 1 to 5 above.

In a first embodiment, a connecting system (cf. 10 in FIG. 5) is provided for contact-connecting busbars having different thicknesses, comprising a first busbar element (cf. 1 in FIG. 1; 11a or 11b in FIG. 5) having a first thickness (cf. d1 in FIG. 1; d11a or d11b in FIG. 5) and having an opening (cf. 1a in FIG. 1; 111a or 111b in FIG. 5) formed in the first busbar element (cf. 1 in FIG. 1; 11a or 11b in FIG. 5) and a second busbar element (cf. 2 in FIG. 2; 3a or 3b in FIG. 4; 13a or 13b in FIG. 5) having a second thickness (cf. d2 in FIG. 2; d13a and d13b in FIG. 5) and having a plug-in connector (cf. 2b in FIG. 2; 3a2 or 3b2 in FIG. 4; 13a2 or 13b2 in FIG. 5) integrally formed on the second busbar element (cf. 2 in FIG. 2; 3a or 3b in FIG. 4; 13a or 13b in FIG. 5), which is configured for a plug-in connection with the opening (cf. 1a in FIG. 1; 111a or 111b in FIG. 5) formed in the first busbar element (cf. 1 in FIG. 1; 11a or 11b in FIG. 5), wherein the first thickness (cf. d1 in FIG. 1; d11a or d11b in FIG. 5) is greater than the second thickness (cf. d2 in FIG. 1; d13a or d13b in FIG. 5).

In a second embodiment, the connecting system (cf. 10 in FIG. 5) is provided in accordance with the first embodiment, wherein the first busbar element (cf. 1 in FIG. 1; 11a or 11b in FIG. 5) comprises a busbar for the power supply.

In a third embodiment, the connecting system (cf. 10 in FIG. 5) is provided in accordance with the first or second embodiment, wherein the second busbar element (cf. 2 in FIG. 2; 3a or 3b in FIG. 4; 13a or 13b in FIG. 5) comprises a lead frame.

In a fourth embodiment, the connecting system (cf. 10 in FIG. 5) is provided in accordance with one of the first to third embodiment, wherein the opening (cf. 1a in FIG. 1; 111 a or 111b in FIG. 5) is a punched hole in the first busbar element (cf. 1 in FIG. 1; 11a or 11b in FIG. 5).

In a fifth embodiment, the connecting system (cf. 10 in FIG. 5) is provided in accordance with one of the first to fourth embodiment, wherein the plug-in connector (cf. 2b in FIG. 2; 3a2 or 3b2 in FIG. 4; 13a2 or 13b2 in FIG. 5) is formed as a rolled or bent plug.

In a sixth embodiment, the connecting system (cf. 10 in FIG. 5) is provided in accordance with the fifth embodiment, wherein the rolled or bent plug is provided in the form of a rolled or bent socket or a round pin.

In a seventh embodiment, the connecting system (cf. 10 in FIG. 5) is provided in accordance with one of the first to sixth embodiment, wherein the plug-in connector (cf. 2b in FIG. 2; 3a2 or 3b2 in FIG. 4; 13a2 or 13b2 in FIG. 5) is configured for the form-fitting and force-fitting connection to the opening (cf. 1a in FIG. 1; 111a or 111b in FIG. 5) and is connected to the opening (cf. 1a in FIG. 1; 111a or 111b in FIG. 5).

In an eighth embodiment, the connecting system (cf. 10 in FIG. 5) is provided in accordance with one of the first to the seventh embodiment, wherein a ratio of the first thickness (cf. d1 in FIG. 1; d11a or d11b in FIG. 5) to the second thickness (cf. d2 in FIG. 2; d13a and d13b in FIG. 5) is greater than 1.5, preferably at least 2.

In a ninth embodiment, the connecting system (cf. 10 in FIG. 5) is provided in accordance with one of the first to the eighth embodiment, wherein the first thickness (cf. d1 in FIG. 1; d11a or d11b in FIG. 5) is at least 2 mm, preferably at least 2.5 mm, and/or is in a range from 3 to 4 mm. In a tenth embodiment, the connecting system (cf. 10 in FIG. 5) is provided in accordance with one of the first to the ninth embodiment, wherein the second thickness (cf. d2 in FIG. 2; d13a and d13b in FIG. 5) is smaller than 2 mm, preferably at most 1.5 mm, and/or is in a range from 0.6 to 1.2 mm.

In an eleventh embodiment, the connecting system (cf. 10 in FIG. 5) is provided in accordance with one of the first to the tenth embodiment. wherein the connecting system (cf. 10 in FIG. 5) further comprises a third busbar element (cf. 11b in FIG. 5) having a third thickness (cf. d11b in FIG. 5) and an opening (cf. 111b in FIG. 5) formed in the third busbar element (cf. 11b in FIG. 5), a fourth busbar element (cf. 13b in FIG. 5) having a fourth thickness (cf. d13b in FIG. 5) and a plug-in connector (cf. 13b2 in FIG. 5) integrally formed on the fourth busbar element (cf. 13b in FIG. 5), which is configured for a plug-in connection with the opening (cf. 111b in FIG. 5) formed in the third busbar element (cf. 11b in FIG. 5), and a carrier (cf. 13c in FIG. 5) having a surface (cf. 13c1 in FIG. 5) in which a plurality of lugs (cf. 13d in FIG. 5) through which the first and third busbar elements (cf. 13a and 13b in FIG. 5) are attached to the carrier (cf. 13c in FIG. 5).

In a twelfth embodiment, the connecting system (cf. 10 in FIG. 5) is provided in accordance with the eleventh embodiment, wherein the third thickness (cf. in FIG. 5: d1, d11a; d11b) is greater than the second and/or fourth thickness (cf. in FIG. 5: d2; d13a; d13b).

In a thirteenth embodiment, the connecting system (cf. 10 in FIG. 5) is provided in accordance with the eleventh or twelfth embodiment, wherein the lugs (cf. 13d in FIG. 5) are provided by pins integrally formed on the carrier (cf. 13c in FIG. 5), which engage with positioning and alignment openings (not provided with a reference sign in FIG. 5) formed in the first and third busbar elements (cf. 13a and 13b in FIG. 5), so that the first and third busbar elements (cf. 13a and 13b in FIG. 5) are attached to the carrier (cf. 13c in FIG. 5) in a predetermined alignment and orientation to one another, such that the first and third busbar elements (cf. 13a and 13b in FIG. 5) fixed on the carrier (cf. 13c in FIG. 5) provide a capacitive component (cf. 13 in FIG. 5).

In a fourteenth embodiment, the connecting system (cf. 10 in FIG. 5) is provided in accordance with one of the eleventh to the thirteenth embodiment, wherein at least one of the third busbar element (cf. 11b in FIG. 5) and the fourth busbar element (cf. 13b in FIG. 5) is configured in accordance with one of the first busbar element (cf. 11a in FIG. 5) and the second busbar element (cf. 13b in FIG. 5) in accordance with one of the second to tenth embodiments, as specified in various configurations below.

In a first configuration of the fourteenth embodiment, the third busbar element (cf. 11b in FIG. 5) can comprise a busbar for power supply.

In a second configuration of the fourteenth embodiments, in addition or alternatively, the fourth busbar element (cf. 13b in FIG. 5) can comprise a lead frame.

In a third configuration of the fourteenth embodiments, in addition or alternatively, the opening (cf. 111b in FIG. 5) in the third busbar element (cf. 11b in FIG. 5) can be a hole punched in the third busbar element (cf. 11b in FIG. 5).

In a fourth configuration of the fourteenth embodiment, in addition or alternatively, the plug-in connector (cf. 13b2 in FIG. 5) of the fourth busbar element (cf. 13b in FIG. 5) can be configured as a rolled or bent plug. For example, the rolled or bent plug can be provided in the form of a rolled or bent socket or a round pin.

In a fifth configuration of the fourteenth embodiment, in addition or alternatively, the plug-in connector (cf. 13b2 in FIG. 5) of the fourth busbar element (cf. 13b in FIG. 5) can be configured for the form-fitting and force-fitting connection with the opening (cf. 111b in FIG. 5) in the third busbar element (cf. 11b in FIG. 5) and be connected to the opening (cf. 111b in FIG. 5) in the third busbar element (cf. 11b in FIG. 5).

In a fifth configuration of the fourteenth embodiment, additionally or alternatively, a ratio of the third thickness (cf. d11b in FIG. 5) to the second and/or fourth thickness (cf. d2 in FIG. 2; d13a and/or d13b in FIG. 5) can be greater than 1.5, preferably at least 2.

In a sixth configuration of the fourteenth embodiment, additionally or alternatively, the third thickness (cf. d11b in FIG. 5) can be at least 2 mm, preferably at least 2.5 mm, and/or can be in a range from 3 to 4 mm.

In a seventh configuration of the fourteenth embodiment, the fourth thickness (cf. d13b in FIG. 5) may be less than 2 mm, preferably at most 1.5 mm, and/or in a range from 0.6 to 1.2 mm.

In the embodiments described above with reference to the Figures, the second busbar element has the second thickness at least at the plug-in connector. For example, the second busbar element can have the second thickness at the plug-in connector as a constant or substantially constant thickness. If the second thickness at the plug-in connector is an averaged thickness, a maximum thickness at the plug-in connector is smaller than the first thickness.

1. A connecting system for contact-connecting busbars having different thicknesses, comprising:
a first busbar element having a first thickness and having an opening, that is formed in the first busbar element; and
a second busbar element having a second thickness and having a plug-in connector that is integrally formed on the second busbar element which is configured to form a plug-in connection with the opening formed in the first busbar element,
wherein the first thickness is greater than the second thickness.

2. The connecting system according to claim 1, wherein the first busbar element comprises a busbar for the power supply.

3. The connecting system according to claim 1, wherein the second busbar element comprises a lead frame.

4. The connecting system according to claim 1, wherein the opening is a hole punched in the first busbar element.

5. The connecting system according to claim 1, wherein the plug-in connector is formed as a rolled or bent plug.

6. The connecting system according to claim 5, wherein the rolled or bent plug is provided in the form of a rolled or bent socket or a round pin.

7. The connecting system according to claim 1, wherein the plug-in connector is configured for a form-fitting and force-fitting connection with the opening and is connected to the opening.

8. The connecting system according to claim 1, wherein a ratio of the first thickness to the second thickness is greater than 1.5.

9. The connecting system according to claim 1, wherein the first thickness is at least 2 mm.

10. The connecting system according to claim 1, wherein the second thickness is less than 2 mm.

11. The connecting system according to claim 1, further comprising:
a third busbar element having a third thickness and having an opening formed in the third busbar element;
a fourth busbar element, having a fourth thickness and having a connector that is integrally formed on the fourth busbar element which is configured for a plug-in connection with the opening formed in the third busbar element and
a carrier having a surface in which a plurality of lugs are formed, by which the first and third busbar elements are attached to the carrier.

12. The connecting system according to claim 11, wherein the third thickness is greater than the second and/or fourth thickness.

13. The connecting system according to claim 11, wherein the lugs are provided by pins that are integrally formed on the carrier and engage with positioning and alignment openings that are formed in the first and third busbar elements, so that the first and third busbar elements are attached to the carrier in a predetermined alignment and orientation to one another, such that the first and third busbar elements fixed on the carrier provide a capacitive component.

14. The connecting system according to claim 11, wherein at least one of the third busbar element and the fourth busbar element is configured according to one of the first busbar element and the second busbar element.

15. The connecting system according to claim 1, wherein a ratio of the first thickness to the second thickness is greater than at least 2.

16. The connecting system according to claim 1, wherein the first thickness is at least 2.5 mm.

17. The connecting system according to claim 1, wherein the first thickness is in a range from 3 to 4 mm.

18. The connecting system according to claim 1, wherein the second thickness is at most 1.5 mm.

19. The connecting system according to claim 1, wherein the second thickness is in a range from 0.6 to 1.2 mm.
